(19) United States
(12) Patent Application Publication
(10) Pub. No.: US 2015/0205595 A1
(43) Pub. Date: Jul. 23, 2015

(54) METHOD AND SYSTEM FOR INTELLIGENT CONFIGURATION OF A NATIVE APPLICATION

(71) Applicant: VONAGE NETWORK LLC, Holmdel, NJ (US)

(72) Inventor: Sagi Dudai, Tel-Aviv (IL)

(21) Appl. No.: 14/192,266

(22) Filed: Feb. 27, 2014

Related U.S. Application Data
(60) Provisional application No. 61/929,340, filed on Jan. 20, 2014.

(51) Int. Cl. G06F 9/445; G06F 9/44

(52) U.S. Cl. CPC G06F 8/65; G06F 9/44505; G06F 8/71

(57) ABSTRACT

Methods and systems for intelligently configuring a native application are provided herein. In some embodiments, a method for intelligently configuring a native application installed on a user device associated with a user may include determining application configuration settings for the native application based on (a) user information and (b) an application usage profile of the native application, and configuring the native application based on the determined application configuration settings.

### CROSS-REFERENCE TO RELATED APPLICATIONS

This application claims benefit of U.S. Provisional Patent Application Ser. No. 61/929,340, filed Jan. 20, 2014, which is herein incorporated by reference.

### BACKGROUND

1. Field

Embodiments of the present invention generally relate to methods and systems that observe and determine user application usage patterns/profiles, and use user profile information, to configure customized application user interfaces (UI) and application logic flow for individual users.

2. Description of the Related Art

While Web applications are designed to be very dynamic and can be updated/customized on the fly, native mobile device applications installed on mobile devices tend to be relatively static in comparison. Developers use static application flows (i.e., the series of steps to perform a given task), designs, and layouts to build native applications which result in static applications. For example, once an application is installed on a mobile device and launched, the user will typically have to undergo first time application flow to register/create and account. After the first time application flow is performed, every time the user launches the application, they will typically see the same user interface layout until the application developer decides to modify the design and releases a new version that has to be downloaded and installed. For example, a mobile communication application may always display the same 5 tabs on the main screen (e.g., contacts, keyboard, events, chat, settings) every time the application is launched until a new version of the application is released by the developer. In addition, the display of each tab will always look the same until the product developer decides differently and releases a new version.

The static display and user flow of various features may result in a waste of resources (i.e., screen space, computing resources, time, and the like). For example, in the mobile communication application above, some users may never use the chat feature and always use the keyboard feature to call a contact. For these users, the chat tab can only cause confusion and is a waste of important screen space.

Accordingly, there exists a need in the art for more intelligent and contextually aware methods and systems to configure customized application user interfaces and application flows for individual based on application usage patterns/profiles and information about a user.

### SUMMARY

Methods and systems for intelligently configuring a native application are provided herein. In some embodiments, a method for intelligently configuring a native application installed on a user device associated with a user may include determining application configuration settings for the native application based on (a) user information and (b) an application usage profile of the native application, and configuring the native application based on the determined application configuration settings.

In some embodiments, a method for intelligently configuring a native application installed on a user device associated with a user may include providing a first configuration of the native application on the user device, storing interaction with the native application as application usage history, determining application configuration settings based on at least one of (a) user information or (b) the application usage history, and providing a second configuration of the native application on the user device based on the determined application configuration settings.

In some embodiments, a system for intelligently configuring a native application installed on a user device associated with a user may include an application usage profile determination module configured to determine an application usage profile based on application usage records associated with the user, an application configuration module configured to create one or more application configuration settings based at least one of (a) user information or (b) the application usage profile determined by the application usage profile determination module, a user interface (UI) creation module configured to create a UI based on application configuration settings determined by the application configuration module, and an application workflow creation module configured to create a application workflow based on application configuration settings determined by the application configuration module.

Other and further embodiments of the present invention are described below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a block diagram of a telecommunication network, according to one or more embodiments of the invention;

FIG. 2 depicts a block diagram of a system for providing intelligent application configuration of a native applications, according to one or more embodiments of the invention;

FIG. 3 is a bubble chart of operations of a system for providing intelligent application configuration of a native applications, according to one or more embodiments of the invention;

FIG. 4 is an exemplary neural network system that may be used for providing intelligent application configuration of a native applications, according to one or more embodiments;

FIG. 5A depicts a flow diagram of a method for providing intelligent application configuration of a native applications, according to one or more embodiments of the invention;

FIG. 5B depicts a flow diagram of a method for obtaining and using a user's application usage history, according to one or more embodiments of the invention; and

FIG. 6 depicts a computer system that can be utilized in various embodiments of the present invention, according to one or more embodiments of the invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present invention generally relate to methods and systems for intelligently and automatically configuring native applications based on user information. More specifically, embodiments of the present invention observe and determine application usage patterns by the user, and use those determined usage patterns along with user profile information to configure customized application user interfaces and application logic flows for individual users. Thus, embodiments of the present invention may advantageously learn a user's preferences for interfacing with a native application installed on a local computing device based on application usage history by the user, user profile information, time of day, user location, user device information, information from other similarly situated users, and other parameters. Individual application usage information for users may be analyzed to intelligently determine how to configure the native application (e.g., how to configure the UI and application flow).

The user may choose to opt into the intelligent application configuration service or select a default static application configuration. Once the intelligent application configuration service is activated, user information and application usage information will be collected and configuration of the application will be modified based on the user information and application usage information. For example, upon initial launch of the native application, the native application will start collecting data about the user and the user's usage (e.g., clicks/selections, views, actions, and the like). The next time the user launches the native application, the UI may be reconfigured to look different based on the user's previous usage. For example, if the user never uses a chat function displayed on the main screen of a mobile communication application, the chat tab will be hidden, or moved to a less prominent position, after X days of non-use and the space will be occupied by other more often-used functionality. In another example, the intelligent application configuration service may determine that a user is an elderly user and the native application may automatically increase the sounds produced by the application (e.g., a louder ringtone) or may automatically display larger selectable objects (e.g., larger keypad buttons).

In embodiments consistent with the present invention, the native application may collect statistical application usage data for users that can be used to customize application configurations for specific users. The data collected for each user may be obtained from application usage, explicitly requested from each user, or it may be collected from external sources such as from a service provider associated with the native application, social media providers, other native applications stored on the computing device, other computing devices associated with the user, and the like.

Some portions of the detailed description which follow are presented in terms of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Some exemplary embodiments described below are with respect to a mobile Voice over Internet Protocol (VOIP) telecommunication app. However, one skilled in the art will readily recognize from the following description that any native application may be used in embodiments consistent with the present invention without departing from the principles of the disclosure described herein.

In the following description, the terms VOIP system, VOIP telephony system, IP system and IP telephony system are all intended to refer to a system that connects callers and that delivers data, text and video communications using Internet protocol data communications. Those of ordinary skill in the art will recognize that embodiments of the present invention are not limited to use with IP telephony systems and may also be used in other systems.

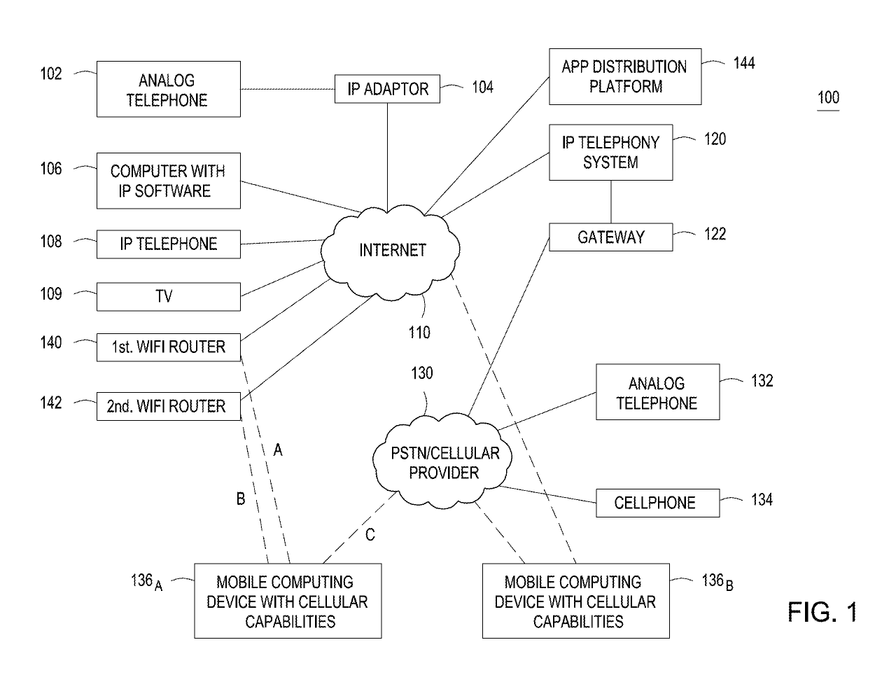

As illustrated in FIG. 1, a communications environment 100 is provided to facilitate IP enhanced communications. An IP telephony system 120 enables connection of telephone calls between its own customers and other parties via data communications that pass over a data network 110. The data network 110 is commonly the Internet, although the IP telephony system 120 may also make use of private data networks. The IP telephony system 120 is connected to the Internet 110. In addition, the IP telephony system 120 is connected to a publicly switched telephone network (PSTN) 130 via a gateway 122. The PSTN 130 may also be directly coupled to the Internet 110 through one of its own internal gateways (not shown). Thus, communications may pass back and forth between the IP telephony system 120 and the PSTN 130 through the Internet 110 via a gateway maintained within the PSTN 130.

The gateway 122 allows users and devices that are connected to the PSTN 130 to connect with users and devices that are reachable through the IP telephony system 120, and vice versa. In some instances, the gateway 122 would be a part of the IP telephony system 120. In other instances, the gateway 122 could be maintained by a third party.

Customers of the IP telephony system 120 can place and receive telephone calls using an IP telephone 108 that is connected to the Internet 110. Such an IP telephone 108 could be connected to an Internet service provider via a wired connection or via a wireless router. In some instances, the IP telephone 108 could utilize a packet-switched network of a cellular telephone system to access the Internet 110.

Alternatively, a customer could utilize an analog telephone 102 which is connected to the Internet 110 via a telephone adapter 104. The telephone adapter 104 converts analog signals from the telephone 102 into data signals that pass over the Internet 110, and vice versa. Analog telephone devices include but are not limited to standard telephones and document imaging devices such as facsimile machines. A configuration using a telephone adapter 104 is common where the analog telephone 102 is located in a residence or business. Other configurations are also possible where multiple analog telephones share access through the same IP adaptor. In those situations, all analog telephones could share the same telephone number, or multiple communication lines (e.g., additional telephone numbers) may provisioned by the IP telephony system 120.

In addition, a customer could utilize a soft-phone client running on a computer 106 or a television 109 to place and receive IP based telephone calls, and to access other IP telephony systems (not shown). The computer 106 may be a personal computer (PC), a tablet device, a gaming system, and the like. In some instances, the soft-phone client could be assigned its own telephone number. In other instances, the soft-phone client could be associated with a telephone number that is also assigned to an IP telephone 108, or to a telephone adaptor 104 that is connected one or more analog telephones 102.

Users of the IP telephony system 120 are able to access the service from virtually any location where they can connect to the Internet 110. Thus, a customer could register with an IP telephony system provider in the U.S., and that customer could then use an IP telephone 108 located in a country outside the U.S. to access the services. Likewise, the customer could also utilize a computer outside the U.S. that is running a soft-phone client to access the IP telephony system 120.

A third party using an analog telephone 132 which is connected to the PSTN 130 may call a customer of the IP telephony system 120. In this instance, the call is initially connected from the analog telephone 132 to the PSTN 130, and then from the PSTN 130, through the gateway 122 to the IP telephony system 120. The IP telephony system 120 then routes the call to the customer's IP telephony device. A third party using a cellular telephone 134 could also place a call to an IP telephony system customer, and the connection would be established in a similar manner, although the first link would involve communications between the cellular telephone 134 and a cellular telephone network. For purposes of this explanation, the cellular telephone network is considered part of the PSTN 130.

In the following description, references will be made to an “IP telephony device.” This term is used to refer to any type of device which is capable of interacting with an IP telephony system to complete an audio or video telephone call or to send and receive text messages, and other forms of communications. An IP telephony device could be an IP telephone, a computer running IP telephony software, a telephone adapter which is itself connected to a normal analog telephone, or some other type of device capable of communicating via data packets. An IP telephony device could also be a cellular telephone or a portable computing device that runs a software application that enables the device to act as an IP telephone. Thus, a single device might be capable of operating as both a cellular telephone that can facilitate voice based session calls, and an IP telephone that can facilitate data based session calls.

The following description will also refer to a mobile telephony device. The term “mobile telephony device” is intended to encompass multiple different types of devices. In some instances, a mobile telephony device could be a cellular telephone. In other instances, a mobile telephony device may be a mobile computing device, such as the APPLE IPHONE, that includes both cellular telephone capabilities and a wireless data transceiver that can establish a wireless data connection to a data network. Such a mobile computing device could run appropriate application software to conduct VoIP telephone calls via a wireless data connection. Thus, a mobile computing device, such as an APPLE IPHONE, a RIM BLACKBERRY or a comparable device running GOOGLE ANDROID operating system could be a mobile telephony device.

In still other instances, a mobile telephony device may be a device that is not traditionally used as a telephony device, but which includes a wireless data transceiver that can establish a wireless data connection to a data network. Examples of such devices include the APPLE IPOD TOUCH and the IPAD. Such a device may act as a mobile telephony device once it is configured with appropriate application software.

FIG. 1 illustrates that a mobile computing device with cellular capabilities 136_{A} (e.g., a smartphone) is capable of establishing a first wireless data connection A with a first wireless access point 140, such as a WiFi or WiMax router. The first wireless access point 140 is coupled to the Internet 110. Thus, the mobile computing device 136_{A} can establish a VOIP telephone call with the IP telephony system 120 via a path through the Internet 110 and the first wireless access point 140.

FIG. 1 also illustrates that the mobile computing device 136_{A} can establish a second wireless data connection B with a second wireless access point 142 that is also coupled to the Internet 110. Further, the mobile computing device 136_{A} can establish either a third wireless data connection C via a packet-switch network provided by a cellular service provider 130 using its cellular telephone capabilities, or establish a voice based session telephone call via a circuit-switched network provided by a cellular service provider 130. The mobile computing device 136_{A} could also establish a VoIP telephone call with the IP telephony system 120 via the second wireless connection B or the third wireless connection C.

Although not illustrated in FIG. 1, the mobile computing device 136_{A} may be capable of establishing a wireless data connection to a data network, such as the Internet 110, via alternate means. For example, the mobile computing device 136_{A} might link to some other type of wireless interface using an alternate communication protocol, such as the WIMAX standard.

Similarly, mobile computing device with cellular capabilities 136_{B} may also be coupled to internet 110 and/or cellular service provider 130. In some embodiments, mobile computing device 136_{B} may be connected to internet 110 via a WIFI or WIMAX connection, and the like, and can also establish a VOIP telephone calls with the IP telephony system 120 similar to mobile computing device 136_{A}. In embodiments of the present invention, communications environment 100 may be used to establish voice based or data based telecommunications sessions between mobile computing device 136_{A} and mobile computing device 136_{B}, depending on various criteria associated with each of the mobile computing devices, as will be described below in more detail.

In the embodiments described above, a device may act as a mobile telephony device once it is configured with appropriate application software that may be downloaded from an app distribution platform 144. For example, mobile computing device 136_{A} may download a VOIP mobile app from app distribution platform 144 and install the VOIP mobile app locally making the app a native application running on mobile computing device 136_{A}.

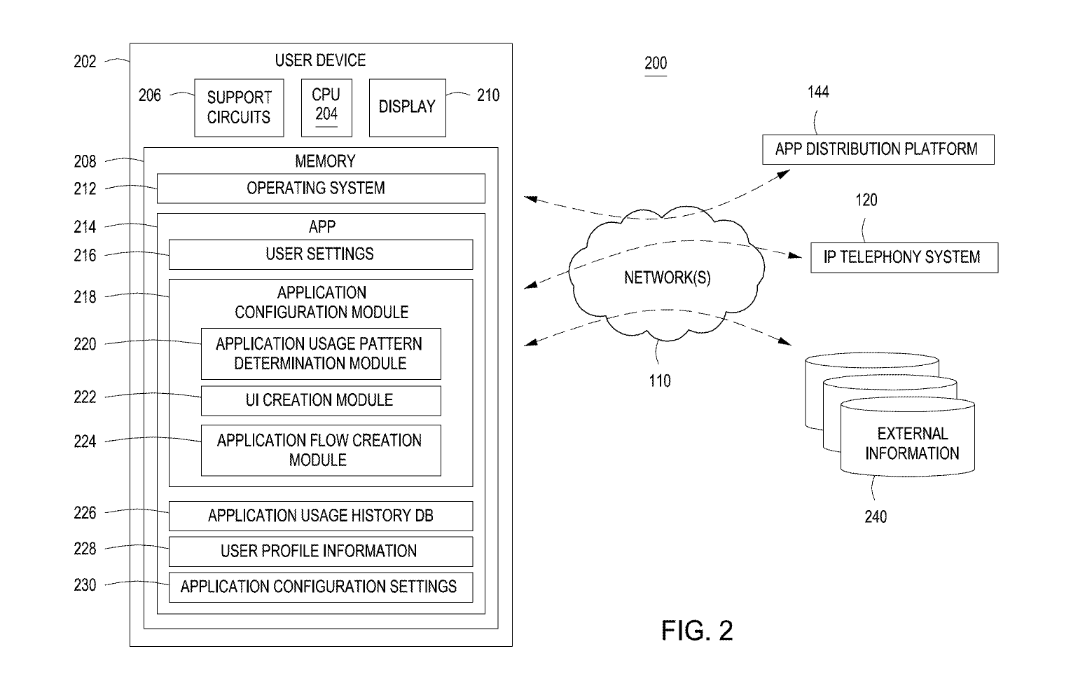

FIG. 2 depicts a block diagram of a system 200 for providing intelligent configuration of applications based on application usage patterns, in addition to user profile information. In some embodiments, as shown in FIG. 2, a user device 202 (such as, for example, mobile computing devices 136_{A}, 136₈) includes a native application 214, such as a mobile telecommunication app, having the inventive intelligent application configuration module 218 for dynamically configuring the native application 214 based on application usage patterns along with user profile information. The user device 202 comprises a Central Processing Unit (CPU) 204, support circuits 206, memory 208, and, in some embodiments, a display device 210. The CPU 204 may comprise one or more commercially available microprocessors or microcontrollers that facilitate data processing and storage. The various support circuits 206 facilitate the operation of the CPU 204 and include one or more clock circuits, power supplies, cache, input/output circuits, and the like. The memory 208 comprises at least one of Read Only Memory (ROM), Random Access Memory (RAM), disk drive storage, optical storage, removable storage and/or the like. In some embodiments, the memory 208 comprises an operating system 212 and the native application 214. The native application 214 may include settings 216, application configuration module 218, application usage history DB 226, user profile information 228, and application configuration settings 230. The application configuration module 218 may include an application usage pattern determination module 220, user interface (UI) creation module 222, and application flow creation module 224.

The operating system (OS) 212 generally manages various computer resources (e.g., network resources, file processors, and/or the like). The operating system 212 is configured to execute operations on one or more hardware and/or software modules, such as Network Interface Cards (NICs), hard disks, virtualization layers, firewalls and/or the like. Examples of the operating system 212 may include, but are not limited to, LINUX, MAC OSX, BSD, UNIX, MICROSOFT WINDOWS, IOS, ANDROID and the like.

Although user settings 216, application usage history database 226, and user profile information 228 are shown as being included in memory 208, those of ordinary skill in the art will recognize these elements may be implemented as separate databases or data storage structures communicatively coupled to the user device 202. In addition, although usage pattern determination module 220, user interface (UI) creation module 222, and application flow creation module 224 are shown as being included in native application 214, those of ordinary skill in the art will recognize that one or more of these elements may be implemented as separate modules executed on remote networks systems communicatively coupled to user device 202 and native application 214.

As shown in FIG. 2, user device 202 may be communicatively coupled to app distribution platform 144, IP telephony system 120, and external information sources 240 via data network 110. In some embodiments, external information sources 240 may include, but is not limited to, a service provider associated with the native application 214, social media providers, other native applications stored on the computing device, other computing devices associated with the user, and the like.

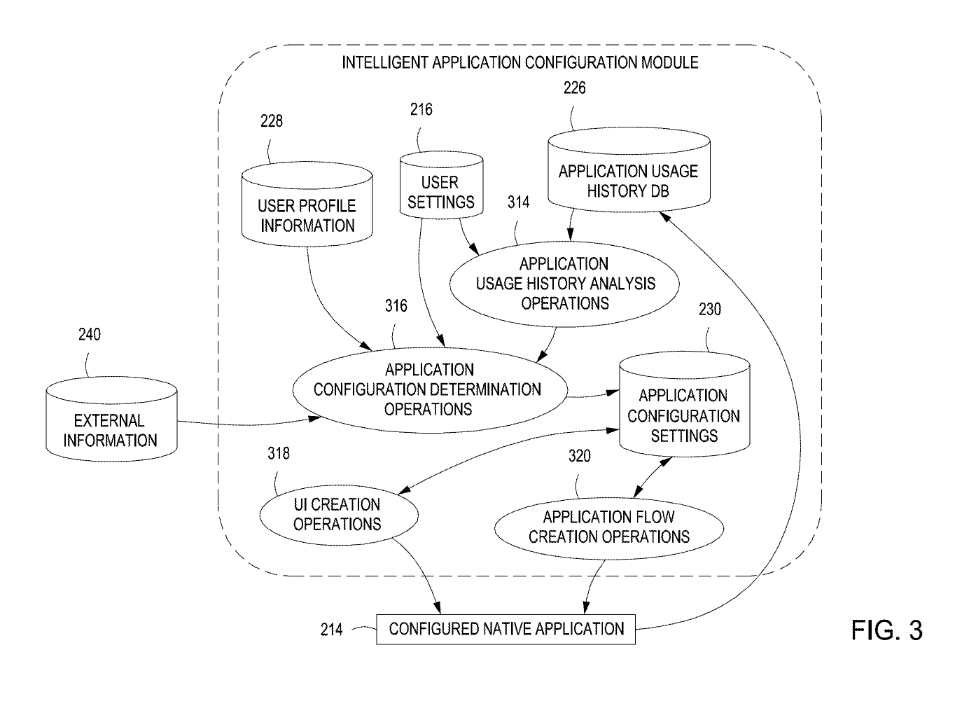

FIG. 3 is a bubble chart 300 of operations of the intelligent application configuration system 200 in accordance with the embodiments of FIG. 2.

Intelligent application configuration services will be provided to users who have opted into, or otherwise enable the service within the native application 214. After the native application 214 is installed, in some embodiments a user registration process may be performed to obtain user specific information. For example, a mobile VOIP communication application may request information from the user, including whether they wish to enable the intelligent application configuration services. In addition, the native application may request user profile information such as, for example, user age, user gender, user preferences, country of origin, email information, social media account information, and the like. In some embodiments, some user specific information may be obtained from social media accounts, GPS information, and the like. A user is free to provide or restrict/permit access to any of the aforementioned information. Even if the user provides no details, application customization can occur based on user behavior (e.g., selections, clicks, etc.).

Users may also be able to disable, or otherwise override, the application configuration service at any time. The intelligent application configuration services may be enabled/disabled in the user settings 216. In some embodiments, the application configuration service will be enabled by default in the native application upon initial installation of the native application.

Once the application configuration service has been enabled within the user settings 216, a history of usage of the application will be stored in application usage history database 226. The application usage history database 226 will include detailed information about how a user uses the application. For example, some non-limiting examples of the information associated usage history may include frequency of usage of various features of the native application, location of the device when certain features were used, time of day when certain features were used, selections/clicks by the user including date/time and location when selection occurred, and the like. In some embodiments, application usage history and user information may be saved regardless of whether or not the user has opted in/turned on the intelligent application configuration service. In other embodiments, application usage history and user information is only saved/updated if the user has turned on the intelligent application configuration service.

Application usage history analysis operations 314 may be performed on application usage history from application usage history database 226 for a user to determine how the user interfaces with the native application. How the user interfaces with the application may include recording clicks, views, actions, and the like associated with various features/functions provided by the application. For example, application usage history analysis operations 314 may include determining that the user makes many international calls when they are at work (i.e., in a specific location between work hours). The application usage history analysis operations 314 will recognize that pattern and provide that information to other operations/modules to configuration that native application such that it will promote international calling features on the application during work hours while at the work location (e.g., the dialer and the contacts tab will be more prominent during work hours when the user is near the work location).

Application usage history analysis operations 314 may be performed, for example, by application usage pattern determination module 220. In some embodiments, application usage history analysis operations may include the use of conditional code within application usage pattern determination module 220 or the use of neural networks within application usage pattern determination module 220 to determine and refine application usage patterns and rules and create an application usage profile for the user. In some embodiments, the native application may include all the logic to make all changes to the UI and application flow locally. In other embodiments, the native application may send user information (application usage history, user settings, and user profile information) to a remote network device which uses the user information to recompile a new version of the native application, and subsequently pushes the changes to the user device 202 (e.g., the user may be prompted to update the native application). Application usage history analysis operations 314 may provide the determined application usage patterns and behaviors of the user to application configuration determination operations 316.

Upon startup of the native application 214, application configuration determination operations 316 utilize the determined application usage patterns received, or otherwise obtained, in addition to user profile information 228 and user settings information 216 to determine how to configure the native application for the user at that particular time. In the example above, application configuration determination operations 316 may receive information from application usage history analysis operations 314 that the user makes many international calls during work hours. The application configuration determination operations 316 may further obtain information from user settings database 216 and user profile 228 to determine how the user wants the application configured.

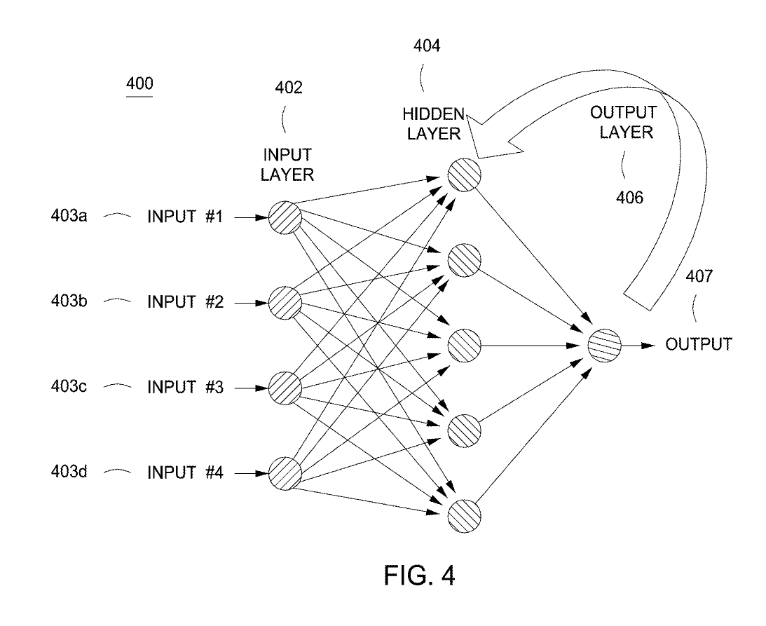

Application usage history analysis operations 314 and/or application configuration determination operations 316 may include the use of neural networks to determine and refine application configuration. That is, the intelligent application configuration system 200 will employ learning algorithms to be used in application usage history analysis operations 314 and application configuration determination operations 316 to determine application usage behaviors and create a customized UI and application flow accordingly. Specifically, as shown in FIG. 4, an exemplary neural network system 400 that may be used by application usage history analysis operations 314 and application configuration determination operations 316. The system 400 may include an input layer 402 and includes a plurality of inputs 403a-d. The inputs (variables) that are chosen may include time of day (at the user's location), day of the week, user information, user's contact book information, the user's location, information associated with what the user was doing at the time of the call (e.g., using calendar information or phone mode settings to determine if the user was in a meeting), a device identifier of the device that the native application was used on, and the like. The inputs 403a-d of the input layer 402 may be obtained from one or more of the application usage history DB 226, user settings DB 216, user profile information 228, and external information sources 240.

The hidden layer 404 operates on the inputs 403a-d of the input layer 402 to provide behavior patterns. Thus, in embodiments consistent with the present invention, the hidden layer 404 is the result of the application usage history analysis operations 314 performed on inputs 403a-d. That is, based on the inputs 403a-d of the input layer 402, the hidden layer 404 includes the determined application usage behaviors of the user as shown in Table 1 below.

The output 407 is the application configuration determined by application configuration determination operations 316 on the given set of inputs 403a-d and the behavior patterns of the hidden layer 404. For example, Table 1 below includes some non-limiting examples of application configurations for a mobile VOIP telecommunication native application that may be determined by application configuration determination operations 316 based on the given set of inputs 403a-d and the behavior patterns of the hidden layer 404, in additional to information from user profile information 228, user settings DB 216, and external information sources 240.

TABLE 1

| Inputs | Hidden Layer Results | Determined Output |
|---|---|---|
| Frequency of usage of | Chat function never | Remove Chat tab from |
| Chat function | used | main screen |
| . . . except during | User uses chat | Display Chat tab during |
| weekly docket | function | weekly docket meeting |
| meetings scheduled | | based on calendar |
| on calendar | | information |
| . . . except if user | Chat function never | Remove Chat tab from |
| is not located in | used | main screen unless user |
| the office | | is located in the office |
| | | during weekly docket |
| | | meeting |

Initially, while the system 400 is learning, the system 400 might provide the same output (i.e., same application configuration) no matter what the inputs are (e.g., show all native application tabs with equal prominence). However, over time, based on the user's behavior in different circumstances, the system learns the optimal behavior for a given set of circumstances/inputs that resulting in changes in the hidden layer. Feedback based on user's behavior will result in gradual formation and modification of configuration settings. Embodiments of the present invention may employ neural networks, pattern recognition, and machine learning algorithms as described in Simon Haykin, Neural Networks and Learning Machines, Third Edition, Pearson Education, New Jersey, 2009; Christopher M. Bishop, Pattern Recognition and Machine Learning, Springer Science, New York, 2006; Neural Networks for Pattern Recognition, Oxford University Press, New York, 1995; B. D. Ripley, Pattern Recognition and Neural Networks, Cambridge University Press, New York, 1996; S. Theodoridis and K. Koutroumbas, Pattern Recognition, Second Edition, Academic Press, New York, 2003; Anil K. Jain, Robert P. W. Quin and Jianchang Mao, “Statistical Pattern Recognition: A Review,” in IEEE Transactions on Pattern Analysis and Machine Intelligence, Vol. 22, No. 1, January 2000; R. O. Duda, P. E. Hart, and D. G. Stork, Pattern Classification, second edition, John Wiley & Sons, New York, 2001; and Bernhard Scholkopf and Alexander J. Smote, Learning with Kernels, The MIT Press, Cambridge, Mass., 2002, each of which is incorporated by reference.

In some embodiments, application configuration determination operations 316 may include obtaining information from external sources 240. The external sources 240 from which the external information is obtained may include, for example, information from a telecommunication service provider associated with the native application regarding the user or other similarly situated users, social media sources such as, for example, LINKEDIN, FACEBOOK, external calendar information, external geolocation information, and the like. For example, application configuration determination operations 316 may obtain information from telecommunication service provider associated with the native application 214 indicating that users under 30 tend to use more emoticons in chat messages. Based on this external information about other users, the application configuration determination operations 316 may determine that additional emoticons should be provided in the user if the user of device 202 is under 30, and will create application configuration settings accordingly.

The determined output from the application configuration operations 316 will be stored as application configuration settings database 230. Application configuration settings database may be any data storage structure capable of storing the configuration settings in a variety of formats, such as, for example, plain text, XML, HTML, TLV, and the like.

Returning to FIG. 3, in operation, when a user launches the native application 214, the application configuration module 218 calls on UI creation module 222 to perform UI creation operations 318, and calls on application flow creation module 224 to perform application flow creation operations 320. UI creation operations 318 and application flow creation operations 320 will use information associated with the device 202 (e.g., current time, location, and other situational context information) and application configuration settings stored in database 230 to configure the native application 214. Some non-limiting examples of native application configurations that may be dynamically created based on user information may include automatically adjusting the size/prominence of UI objects based on frequency of use of features associated with those UI objects, using user profile information in combination with time of day and location to adjust configuration settings (e.g., promoting the chat features for users under 40 from 8 PM until midnight when at home based on application usage history information), make UI objects larger and/or turn ring-tone volume higher for users >65 years old.

Some non-limiting examples of customized application data flows may include providing users more or less prompts/direction for performing certain features based on user information. For example, an older user may be provided additional prompts for recording and sending a video message then would a younger user, or different purchase flows may be provided for various types of users (business v. non-business, young v. old, men v. women, etc.) A purchase flow is the series of steps a user must go through when the user wants buy something within an app. For example, in a mobile VOIP telecommunication app, users might chose to buy credit so they could call remote family off-net (i.e., not entirely on a free VOIP network which would incur costs). A purchase flow in that case would be a set of clicks or series of steps on one or more screens that will result in adding credits to the user's account. Typically, this set of clicks is static (i.e., it looks the same for all users). Anytime a user wants to purchase more credits, he/she will have to take the same steps over and over again. Embodiments consistent with the present invention advantageously and dynamically alter those steps based on the user information. For example, if the application configuration determination operations 316 determines that a user is a business user, application flow creation operations 320 may be performed such that the app will offer the business user during the purchase flow to buy premium services. In another example, if the app determines that a user is below a certain age, purchase flow may be removed altogether for safety.

In some embodiments, the method in which a user invites additional users may be customized based on user profile information. For example, younger users may be walked through a monetization invite flow (e.g., invite a friend, get them to use the service for a certain time period, and get compensated with money, credit, or free service), while business users will have a different invite flow (e.g., send bulk invites to all corporate contacts).

In some embodiments, the application customization settings may include customizing the level of service provided to the user based on the classification of the user. For example, users may be segmented in business users and casual users. Based on this segmentation, the application customization settings determined may provide the business users access to scalable, more robust “business servers” for facilitating the service provided by the native application, while having the casual users directed to servers with less resources and lower quality of service. The same customization may be applied to network routing decisions, the termination partners selected, and the like.

As the user uses native application 214, the usage history will be stored in application usage history database 226.

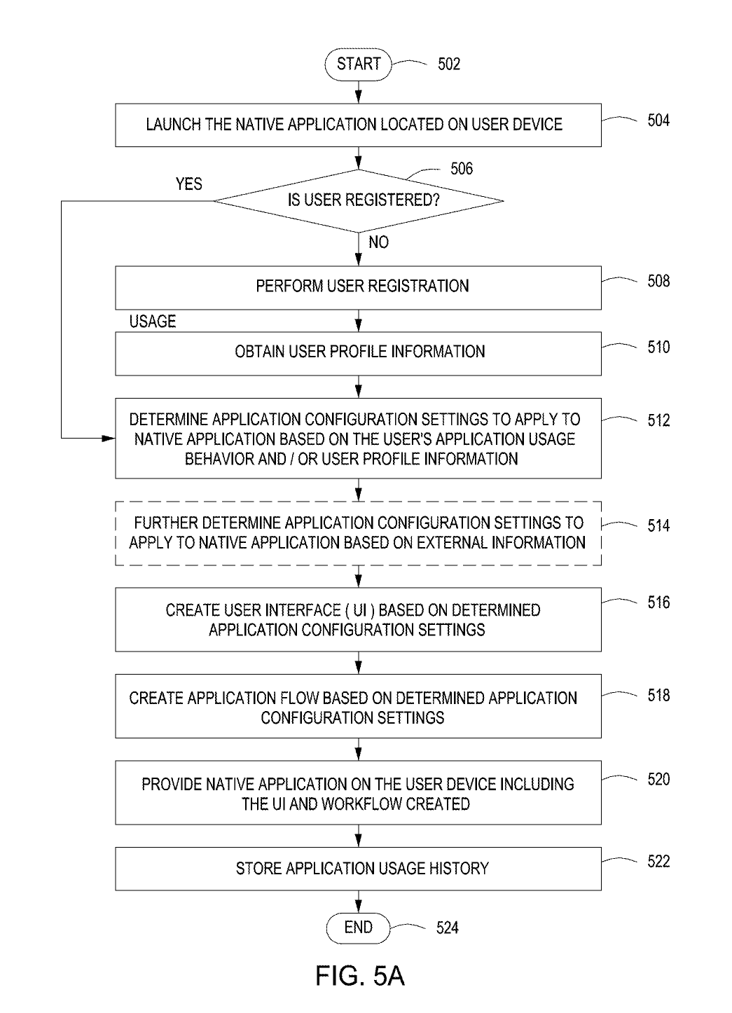

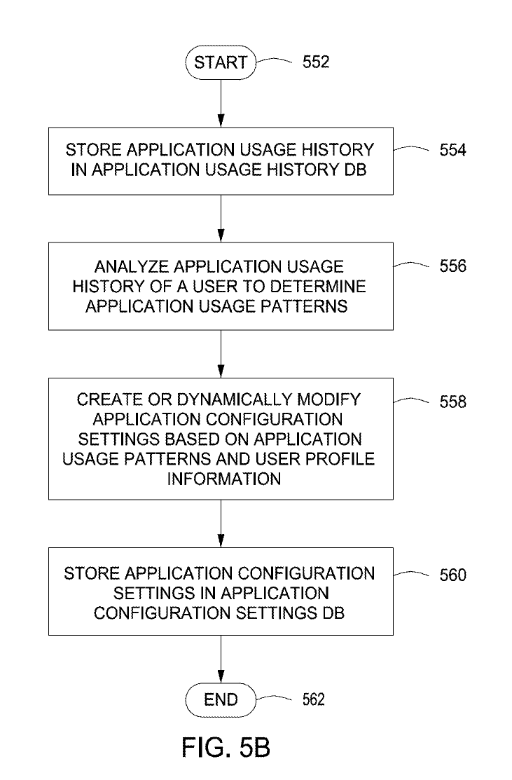

FIG. 5A depicts a flow diagram of a method 500 for providing application configuration of a native application, according to one or more embodiments of the subject invention.

The method begins at 502 and proceeds to 504 where the native application 214 located on the user device is launched on the user device. When the native application 214 is launched for the first time, the user may be required to undergo the registration procedure. Thus, at 506 if the user is not registered, the method proceeds to 508 where user registration is performed. At 510, user profile information 228 may be obtained from the user and stored in association with the native application 214. User profile information requested and obtained at 510 may include, user age, gender, home location, work location, whether the user is a business or non-business user, and the like. After user profile information 228 is obtained, the method proceeds to 512.

If, at 506, it is determined that the user has already been registered and user profile information has already been obtained, the method proceeds to 512 where application configuration settings to apply to the native application are determined based on the user's application usage behavior and/or user profile information obtained.

At 514, application configuration settings may be further refined or determined based on external information from external information sources 240. In some embodiments, the external information from third party services may include information about the user or other users from a service provider associated with the native application, Global Positioning Satellite (GPS) information from GPS services, information from social media services, or information from external calendar sources associated with the user.

At 516, a user interface of the native application may be generated based on the determined application configuration settings. Similarly, at 518, application flow associated with the native application may be based on the determined application configuration settings.

At 520, the native application may be provided on the user device including the user interface and application workflow created, as discussed in steps 516 and 518 above. At 522, the application usage history which represents the user's interaction with the native application may be stored in an application usage history database 226. The method ends at 524.

FIG. 5b depicts a flow diagram of a method 550 for storing and using a user's application usage history information, according to one or more embodiments. The method begins at 552 and proceeds to 554 where application usage history is stored in an application usage history database (as described above in step 522 of method 500). At 556, application usage history stored in application usage history database 226 is analyzed to determine application usage patterns (as described above with respect to FIG. 3 and FIG. 4) and create an application usage history profile. At 558, the determined application usage patterns are used to create or dynamically modify application configuration settings based on application usage patterns and user profile information. The application configuration settings are stored in application configuration settings database 230 at 560. The method 550 ends at 562.

The embodiments of the present invention may be embodied as methods, apparatus, electronic devices, and/or computer program products. Accordingly, the embodiments of the present invention may be embodied in hardware and/or in software (including firmware, resident software, micro-code, and the like), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus or device. More specific examples (a non-exhaustive list) of the computer-readable medium include the following: hard disks, optical storage devices, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java®, Smalltalk or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

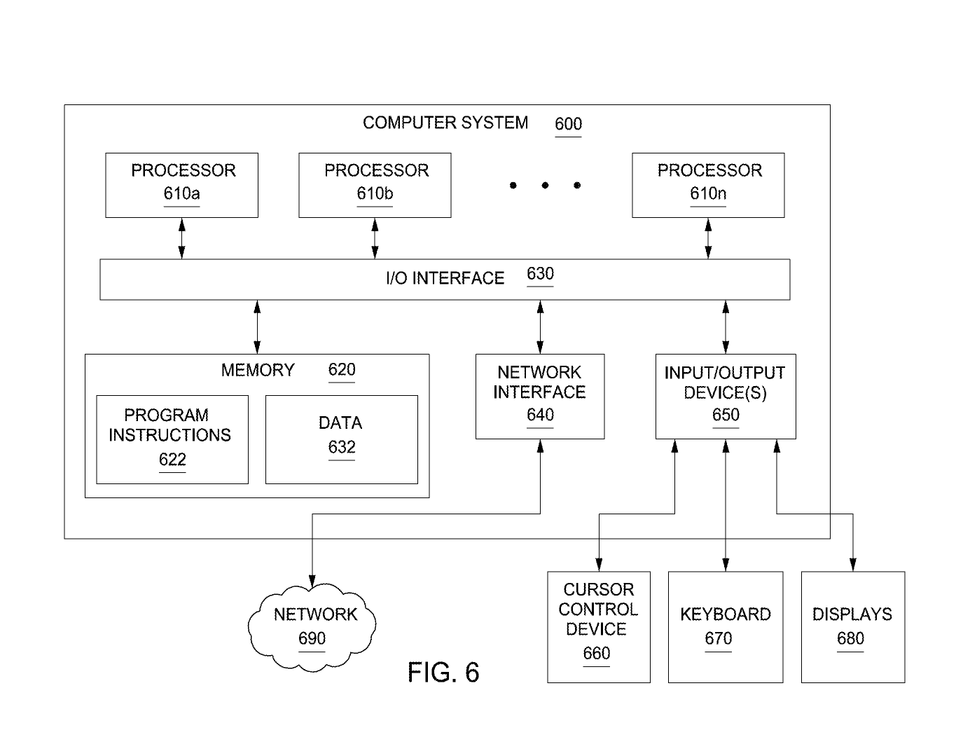

FIG. 6 depicts a computer system 600 that can be utilized in various embodiments of the present invention to implement the computer and/or the display, according to one or more embodiments.

Various embodiments of method and apparatus for organizing, displaying and accessing contacts in a contact list, as described herein, may be executed on one or more computer systems, which may interact with various other devices. One such computer system is computer system 600 illustrated by FIG. 6, which may in various embodiments implement any of the elements or functionality illustrated in FIGS. 1-5B. In various embodiments, computer system 600 may be configured to implement methods described above. The computer system 600 may be used to implement any other system, device, element, functionality or method of the above-described embodiments. In the illustrated embodiments, computer system 600 may be configured to implement methods 500 and 550 as processor-executable executable program instructions 622 (e.g., program instructions executable by processor(s) 610) in various embodiments.

In the illustrated embodiment, computer system 600 includes one or more processors 610a-610n coupled to a system memory 620 via an input/output (I/O) interface 630. Computer system 600 further includes a network interface 640 coupled to I/O interface 630, and one or more input/output devices 650, such as cursor control device 660, keyboard 670, and display(s) 680. In various embodiments, any of the components may be utilized by the system to receive user input described above. In various embodiments, a user interface may be generated and displayed on display 680. In some cases, it is contemplated that embodiments may be implemented using a single instance of computer system 600, while in other embodiments multiple such systems, or multiple nodes making up computer system 600, may be configured to host different portions or instances of various embodiments. For example, in one embodiment some elements may be implemented via one or more nodes of computer system 600 that are distinct from those nodes implementing other elements. In another example, multiple nodes may implement computer system 600 in a distributed manner.

In different embodiments, computer system 600 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 600 may be a uniprocessor system including one processor 610, or a multiprocessor system including several processors 610 (e.g., two, four, eight, or another suitable number). Processors 610 may be any suitable processor capable of executing instructions. For example, in various embodiments processors 610 may be general-purpose or embedded processors implementing any of a variety of instruction set architectures (ISAs). In multiprocessor systems, each of processors 610 may commonly, but not necessarily, implement the same ISA.

System memory 620 may be configured to store program instructions 622 and/or data 632 accessible by processor 610. In various embodiments, system memory 620 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 620. In other embodiments, program instructions and/or data may be received, sent or stored upon different types of computer-accessible media or on similar media separate from system memory 620 or computer system 600.

In one embodiment, I/O interface 630 may be configured to coordinate I/O traffic between processor 610, system memory 620, and any peripheral devices in the device, including network interface 640 or other peripheral interfaces, such as input/output devices 650. In some embodiments, I/O interface 630 may perform any necessary protocol, timing or other data transformations to convert data signals from one component (e.g., system memory 620) into a format suitable for use by another component (e.g., processor 610). In some embodiments, I/O interface 630 may include support for devices attached through various types of peripheral buses, such as a variant of the Peripheral Component Interconnect (PCI) bus standard or the Universal Serial Bus (USB) standard, for example. In some embodiments, the function of I/O interface 630 may be split into two or more separate components, such as a north bridge and a south bridge, for example. Also, in some embodiments some or all of the functionality of I/O interface 630, such as an interface to system memory 620, may be incorporated directly into processor 610.

Network interface 640 may be configured to allow data to be exchanged between computer system 600 and other devices attached to a network (e.g., network 690), such as one or more external systems or between nodes of computer system 600. In various embodiments, network 690 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 640 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 650 may, in some embodiments, include one or more display terminals, keyboards, keypads, touchpads, scanning devices, voice or optical recognition devices, or any other devices suitable for entering or accessing data by one or more computer systems 600. Multiple input/output devices 650 may be present in computer system 600 or may be distributed on various nodes of computer system 600. In some embodiments, similar input/output devices may be separate from computer system 600 and may interact with one or more nodes of computer system 600 through a wired or wireless connection, such as over network interface 640.

In some embodiments, the illustrated computer system may implement any of the operations and methods described above, such as the operations described with respect to FIG. 3 and the methods illustrated by the flowcharts of FIGS. 5A and 5B. In other embodiments, different elements and data may be included.

Those skilled in the art will appreciate that computer system 600 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 600 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 600 may be transmitted to computer system 600 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A method for intelligently configuring a native application installed on a user device associated with a user, comprising:
determining application configuration settings for the native application based on (a) user information and (b) an application usage profile of the native application; and
configuring the native application based on the determined application configuration settings.

2. The method of claim 1, wherein configuring the native application based on the determined application configuration settings includes at least one of creating a user interface (UI) based on the determined application configuration settings, or creating an application workflow based on the determined application configuration settings.

3. The method of claim 2, wherein the application usage profile of the native application is determined by an analysis of application usage history records associated with at least one of the user or the native application.

4. The method of claim 3, wherein each application usage history record includes at least one of information regarding a time and day the application was used by the user, a location of a device when the application was used by the user, a frequency of use of a feature provided by the native application, a number of object selections and associated objects selected, or an indication of a type of action selected.

5. The method of claim 3, wherein the analysis of application usage history records provides a frequency of use of each of one or more features provided by the native application.

6. The method of claim 5, wherein a graphical object that is associated with a feature provided by the native application is configured based on the frequency of use of that feature.

7. The method of claim 1, further comprising:
storing a record of an action performed by the user as at least one application usage history record in an application usage history database.

8. The method of claim 1, wherein the user information includes at least one of age, gender, home location, work location, or whether the user is a business or non-business user.

9. The method of claim 1, wherein determining the application configuration settings is further based on external information from at least one third party service.

10. The method of claim 9, wherein the external information from the at least one third party service includes at least one of information received from a service provider associated with the native application, Global Positioning Satellite (GPS) information, information received from at least one social media service, or information received from at least one external calendar source.

11. The method of claim 1, wherein the application usage profile is determined by a neural network.

12. The method of claim 1, wherein the native application is a mobile Voice over Internet Protocol (VOIP) application.

13. A method for intelligently configuring a native application installed on a user device associated with a user, comprising:
providing a first configuration of the native application on the user device;
storing interaction with the native application as application usage history;
determining application configuration settings based on at least one of (a) user information or (b) the application usage history; and
providing a second configuration of the native application on the user device based on the determined application configuration settings.

14. The method of claim 13, wherein providing a second configuration includes at least one of creating a user interface (UI) based on the determined application configuration settings, or creating a application workflow based on the determined application configuration settings.

15. The method of claim 13, wherein determining the application configuration settings is further based on external information from at least one third party service.

16. The method of claim 13, wherein a neural network is used to determine application usage patterns based on the application usage history.

17. The method of claim 13, wherein the native application is a mobile Voice over Internet Protocol (VOIP) application.

18. A system for intelligently configuring a native application installed on a user device associated with a user, comprising:
an application usage profile determination module configured to determine an application usage profile based on application usage records associated with the user;
an application configuration module configured to create one or more application configuration settings based at least one of (a) user information or (b) the application usage profile determined by the application usage profile determination module;
a user interface (UI) creation module configured to create a UI based on application configuration settings determined by the application configuration module; and
an application workflow creation module configured to create a application workflow based on application configuration settings determined by the application configuration module.

19. The system of claim 18, further comprising:
an application usage history database that stores application usage records associated with at least one of the user or the native application;
an application configuration settings database that stores application configuration settings created by the application configuration module; and
a user profile database to store information about the user.

20. The system of claim 18, wherein the application usage profile determination module includes a neural network configured to determine an application usage profile of the user based on an analysis of application usage records associated with at least one of the user or the native application.
